(19) United States
(12) Patent Application Publication
(10) Pub. No.: US 2025/0373163 A1
(43) Pub. Date: Dec. 4, 2025

(54) RAMP SIGNAL SORTING IN MULTIPHASE POWER CONVERTERS

(71) Applicant: Renesas Electronics America Inc., Milpitas, CA (US)

(72) Inventors: Travis John GUTHRIE, Austin, TX (US); James Robert TOKER, Austin, TX (US)

(73) Assignee: Renesas Electronics America Inc., Milpitas, CA (US)

(21) Appl. No.: 19/209,907

(22) Filed: May 16, 2025

Related U.S. Application Data
(60) Provisional application No. 63/653,384, filed on May 30, 2024.

(51) Int. Cl. H02M 3/158

(52) U.S. Cl. CPC H02M 3/1584

(57) ABSTRACT

Systems and methods that can implement ramp signal sorting in multiphase power converters is generally described. The method can include comparing a plurality of phase currents of a plurality of phases in a multiphase power conversion system. The plurality of phases are mapped to a plurality of ramp signals. The method can further include based on results of comparing the plurality of phase currents, determining new mappings between the plurality of phases and the plurality of ramp signals. The method can further include controlling the plurality of phases according to the new mappings between the plurality of phases and the plurality of ramp signals.

### CROSS-REFERENCE TO RELATED APPLICATION

This application is based upon and claims the benefit of priority under 35 U.S.C. 120 of U.S. Patent Application No. 63/653,384 filed on May 30, 2024, and titled “CROSS POWER MANAGEMENT INTEGRATED CIRCUIT (XPMIC) BABY PHASE ARCHITECTURE,” the entire contents of which are incorporated herein by reference.

### BACKGROUND

The present disclosure relates in general to systems and methods for operating multiphase power converters, particularly, sorting ramp signals to balance phase current in multiphase power converters.

DC-to-DC voltage conversion may be performed by switching voltage regulators or power converters to convert a voltage from a first level to a second level that may be required by a load. One example of such a switching voltage regulator may be the buck converter, which typically switches a pair of power transistors to produce a square-wave at a common node between the pair of power transistors. The produced square-wave may be smoothed out using a resonant circuit (e.g., an inductor-capacitor (LC) circuit) to produce a desired voltage for a load. A feedback control loop may be configured to control a duty-cycle of the produced square-wave and a resulting value of an output voltage of the voltage converter.

One example voltage regulator architecture is a multiphase voltage regulator which includes several phases. Each phase includes a power stage and an inductor. All phases share a controller and the output capacitors. The controller generates PWM signals to the power stages to control the power transistors to turn on and off. The duty cycle of the PWM signals can be adjusted by the controller to obtain the target output voltage. The phases are connected in parallel, and the turn-on of the phases can be interleaved to reduce the output current ripple, output voltage ripple and input current ripple to improve system performance. Each power stage can include a power stage controller. The power stage controller can measure critical parameters (e.g. inductor current and temperature) and feed back to the controller to help optimize the system performance such as phase balance, efficiency and load transients.

### SUMMARY

In one embodiment, a method that can implement ramp signal sorting in multiphase power converters is generally described. The method can include comparing a plurality of phase currents of a plurality of phases in a multiphase power conversion system. The plurality of phases are mapped to a plurality of ramp signals. The method can further include based on results of comparing the plurality of phase currents, determining new mappings between the plurality of phases and the plurality of ramp signals. The method can further include controlling the plurality of phases according to the new mappings between the plurality of phases and the plurality of ramp signals.

In one embodiment, a system that can implement ramp signal sorting in multiphase power converters is generally described. The system can include a multiphase power converter including a plurality of phases. The system can further include a controller configured to compare a plurality of phase currents of the plurality of phases in the multiphase power converter. The plurality of phases are mapped to a plurality of ramp signals. The controller can further be configured to, based on results of comparing the plurality of phase currents, determine new mappings between the plurality of phases and the plurality of ramp signals. The controller can further be configured to control the plurality of phases according to the new mappings between the plurality of phases and the plurality of ramp signals

In one embodiment, a semiconductor device that can implement ramp signal sorting in multiphase power converters is generally described. The semiconductor device can include a plurality of comparators configured to compare a plurality of phase currents of a plurality of phases in a multiphase power conversion system. The plurality of phases are mapped to a plurality of ramp signals. The semiconductor device can further include a mapping circuit configured to determine, based on results of comparing the plurality of phase currents, new mappings between the plurality of phases and the plurality of ramp signals. The semiconductor device can further include a modulator configured to generate at least one pulse-width modulation (PWM) signal for controlling the plurality of phases according to the new mappings between the plurality of phases and the plurality of ramp signals.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing an example system that can implement ramp signal sorting in multiphase power converters in one embodiment.

FIG. 2 is a diagram showing an example set of staggered control signals in multiphase power converters.

FIG. 3A is a diagram showing various waveforms of a multiphase power converter.

FIG. 3B is another diagram showing various waveforms of a multiphase power converter.

FIG. 4A is a diagram showing an example controller that can implement ramp signal sorting in multiphase power converters in one embodiment.

FIG. 4B is a diagram showing a reordering of ramp signals during an implementation of ramp signal sorting in multiphase power converters in one embodiment.

FIG. 5 illustrates a flow diagram of a process to implement ramp signal sorting in multiphase power converters in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

In an aspect, modern graphics processors and application processors may require dedicated point-of-load power converters to provide a regulated low voltage source in order to deliver high load currents. With increasing power density requirements, power converters operating at high switching frequencies with reduced size of passive components, such as filter inductors and capacitors, may be desirable. To improve operational efficiencies and reduce thermal stress, the power converter may need to respond to relatively high skew rates (e.g., change of current over time) during different operating modes, such as a heavy load mode where high current is demanded during heavy computations and a light load mode where low current is demanded during standby or idle modes. Multiphase voltage regulators can be employed to handle the varying skew rates under these different operating conditions.

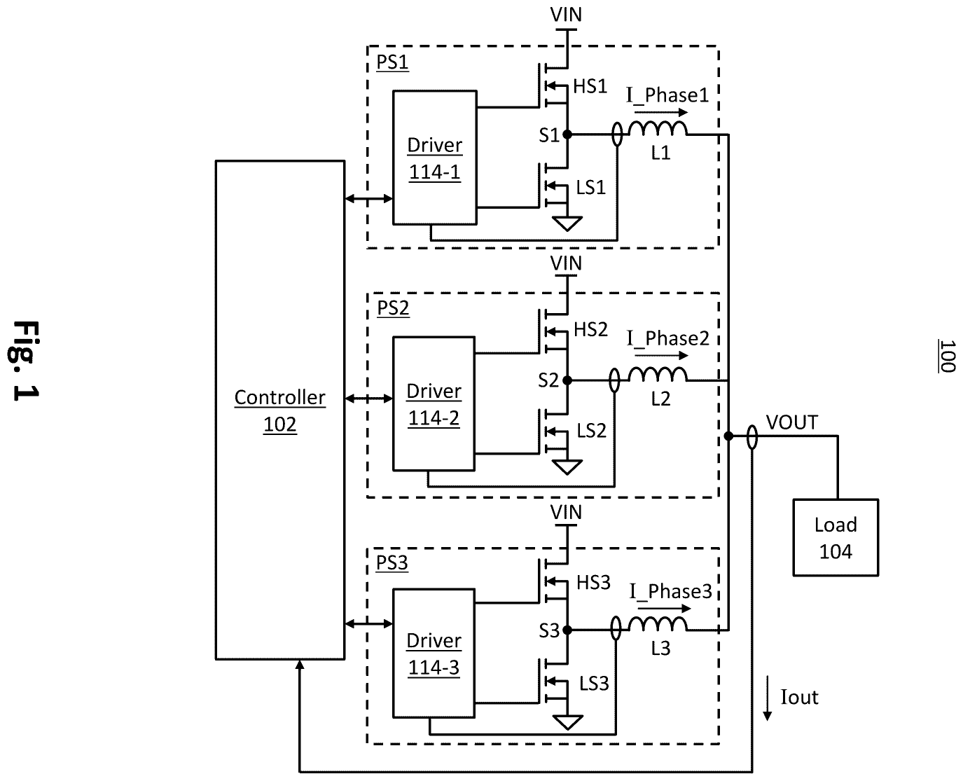

FIG. 1 is a diagram showing an example system that can implement ramp signal sorting in multiphase power converters in one embodiment. A system 100 shown in FIG. 1 can be a multiphase power conversion system. System 100 can include a controller 102 and at least one power stage. In the example shown in FIG. 1, system 100 includes three power stages labeled as PS1, PS2, PS3. System 100 can implement a multiphase DC-DC buck converter that can convert (e.g., step down) can an input voltage VIN (a DC voltage) into an output voltage VOUT (also a DC voltage), where VOUT has a lower voltage level than VIN. System 100 can include an arbitrary number of power stages. The output voltage VOUT can be provided to a load 104.

Each one of the power stages can be a phase of the multiphase power conversion system. Each power stage can include a driver circuit (“driver”), one or more high-side power devices, one or more low-side devices, and an output inductor. As shown in FIG. 1, power stage PS1 can include a driver 114-1, a high-side power device HS1, a low-side power device LS1 and an output inductor L1. Power stage PS2 can include a driver 114-2, a high-side power device HS2, a low-side power device LS2 and an output inductor L2. Power stage PS3 can include a driver 114-3, a high-side power device HS3, a low-side power device LS3 and an output inductor L3. Drivers 114-1, 114-2, 114-3 can be collectively referred to as drivers 114. The high-side and low-side devices can be switching elements, such as switches and/or field-effect transistors (FETs) including metal-oxide-semiconductor field-effect transistors (MOSFETs).

Controller 102 can be formed by one or more semiconductor devices. Controller 102 can be configured to control or regulate the operations of the power stages in system 100. Controller 102 can be an integrated circuit including, for example, a processor, central processing unit (CPU), field-programmable gate array (FPGA), various analog and/or digital logic circuits, or any other circuitry that is configured to operate various aspect of system 100, such as controlling and operating drivers 114 in the power stages of system 100. While described as a CPU in illustrative embodiments, controller 102 is not limited to a CPU in these embodiments and may comprise any other circuitry that is configured to control and operate drivers 114.

Controller 102 can be configured to generate control signals, such as pulse width modulation (PWM) signals, and provide the generated control signals to drivers 114. Drivers 114 can generate gate current for driving the gates of the high-side and low-side power devices to switch them alternately. For example, controller 102 can generate a first PWM signal for driver 114-1 and driver 114-1 can generate a gate current based on the first PWM signal. The gate current generated by driver 114-1 can flow to the gates of power devices HS1 and LS1 alternately to switch HS1 and LS1 alternately. The alternate switching of HS1 and LS1 can generate a switch node voltage at node S1. The switch node voltage at node S1 can cause current to flow towards load 104 and also charge output inductor L1. The current flowing through inductor L1 is labeled as inductor current I_Phase1. Similarly, controller 102 can generate a second PWM signal for driver 114-2 and a third PWM signal for driver 114-3. Driver 114-2 can alternately switch of HS2 and LS2 and driver 114-3 can alternately switch of HS3 and LS3. The switch node voltage at node S2 and the switch node voltage at node S3 can cause current I_Phase2 and I_Phase3, respectively, to flow towards load 104.

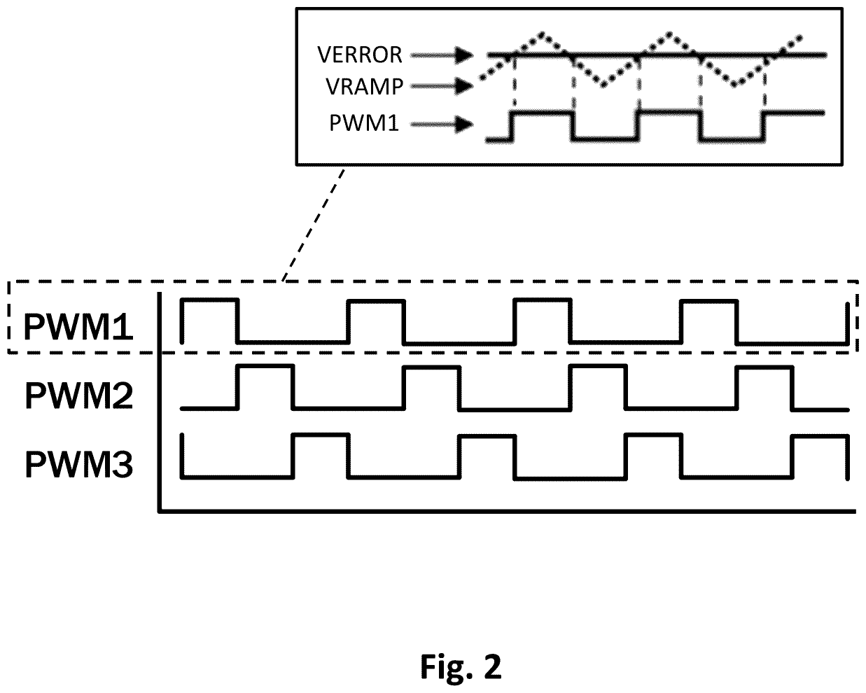

FIG. 2 is a diagram showing an example set of staggered control signals in a fixed order in multiphase power converters. Descriptions of FIG. 2 can reference components shown in FIG. 1. The different control signals generated by controller 102 for different power stages can be staggered at spaced intervals such that only one power stage is active at any given time. As shown in FIG. 2, controller 102 can include a PWM modulator configured to generate control signals PWM1, PWM2, PWM3 for controlling power stages PS1, PS2, PS3, respectively. The control signals PWM1, PWM2, PWM3 can be staggered and out of phase such that only one control signal is HIGH in any given time. Due to the control signals for different power stages being staggered, the inductor currents I_Phase1, I_Phase2 and I_Phase3 are also out of phase and Iout can be less than each individual inductor current among I_Phase1, I_Phase2 and I_Phase3.

Controller 102 can be configured to monitor each inductor current and adjust them separately to ensure the current drawn from each phase is equal. The process to ensure the phase currents are equal is referred to as phase balancing (or current sharing, or current balancing). Phase balancing can allow the control signals being generated by controller 102 to remain at a constant on-time, instead of varying on times that can lead to instability. In an aspect, current imbalance can occur due to varying characteristics of current sense amplifiers in different phases being used for measuring the different phase currents, such as offset differences and/or gain difference of the current sense amplifiers. When the phases are unbalanced, individual phases can supply unbalanced portions of the total load current or output current. The unbalanced phases can result in various issues such as concentration of component stress and heat distribution which can cause reduced reliability, thermal run-away, and system failure.

When system 100 operates under voltage mode control, controller 102 can monitor output voltages from each phase, such as the switch node voltages at switch nodes S1, S2, S3 of power stages PS1, PS2, PS3, respectively. Controller 102 can subtract each one of the switch node voltages from a reference voltage (e.g., a target or desired voltage level of Vout) to determine error signals VERROR for the three phases. Under voltage mode, a ramp signal VRAMP can be generated by a ramp generator in controller 102 for each phase (e.g., N ramp signals for N phases). When system 100 operates under current mode control, controller 102 can monitor output currents I_Phase1, I_Phase2 and I_Phase3 from each power stage and generate the ramp signals based on the slopes of the inductor currents. In one or more embodiments, the ramp signal VRAMP can have a sawtooth waveform as shown in FIG. 2. Each one of the error signals can be compared to a ramp signal. The outputs of the comparisons can be PWM signals for switching the power devices in respective power stages. In an example shown in FIG. 1, the control signal PWM1 of power stage PS1 can be based on the difference, which is the comparison output, between VERROR and VRAMP for power stage PS1. When VRAMP is greater than VERROR, PWM1 is HIGH and when VRAMP is less than VERROR, PWM1 is low.

In an aspect, some power conversion systems can operate in an on-demand mode where controller 102 can activate different amount of phases based on current demand by load 104. An activated power stage is a power stage that is selected for contributing to the regulation of VOUT and a deactivated power stage is a power stage that is not selected for contributing to the regulation of VOUT. If output current Iout increases, controller 102 can perform a phase add by activating additional phases and generating additional PWM control signals for controlling the additionally activated phases. If output current Iout decreases, controller 102 can perform a phase drop by deactivating phases and stop generation of PWM control signals the deactivated phases. For power conversion systems operating in on-demand mode, the output current Iout can toggle between high output current and low output current relatively rapidly. Also, the frequency of switching between on-demand mode and other modes can be relatively high. If the load demand changes at frequencies or rates that are relatively close to the frequency of ramp signals VRAMP, then a pseudo-resonance between the switching frequencies of the phases can be created, leading to phase-by-phase current imbalance.

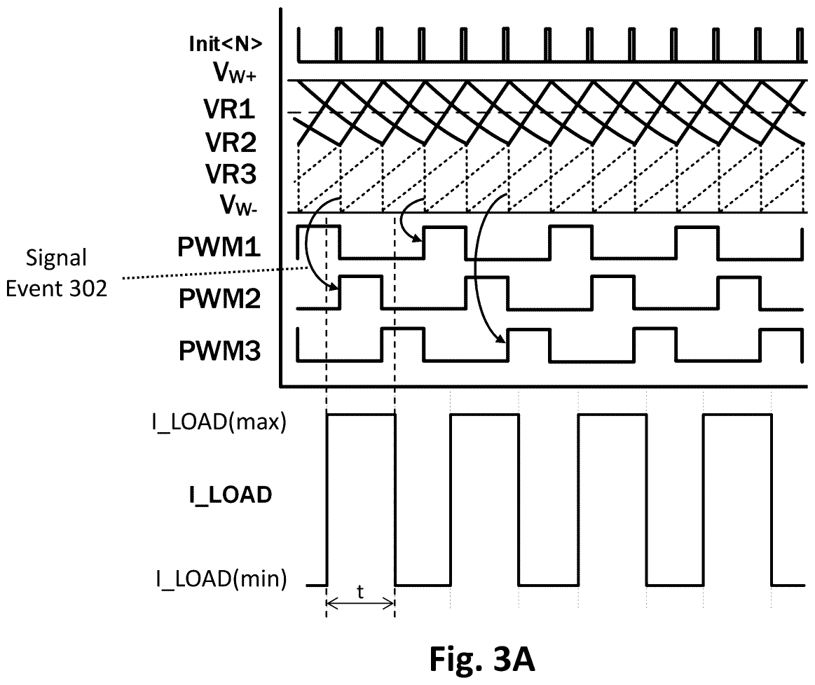

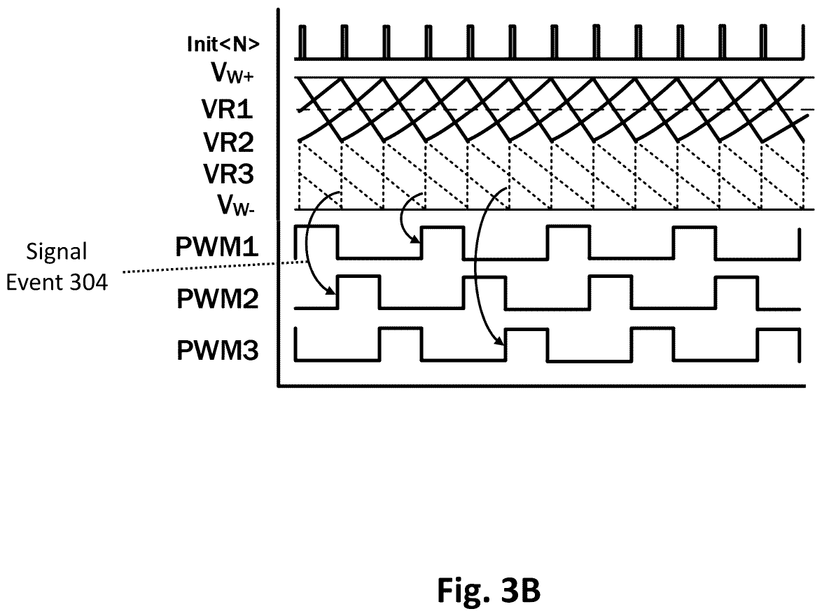

FIG. 3A and FIG. 3B are diagrams showing various waveforms of a multiphase power converter. Description of FIG. 3A can reference components shown in FIG. 1 and FIG. 2. As shown in an example in FIG. 3A, the ordering of the staggered control signals PWM1, PWM2, PWM3 can be fixed, such as the order of PWM1, PWM2, PWM3. This fixed phase order and the interleaving of the ramp signals (e.g., dotted lines in FIG. 2, FIG. 3A and FIG. 3B) for each phase can be in a round robin scheduling scheme. The round robin interleaving can reduce the amount of filter components in system 100 and provide current sharing and balancing between the phases. The voltages Vw+ and Vw− are the upper and lower bounds a current limit window to ensure the correct switching frequency is being used for switching the phases.

However, under this sequential phase control with fixed order, there can be situations where the output load is at the maximum current during the entire time that a specific phase is delivering current to the load, while the output load current is at the maximum current only partially during the times when other phases are delivering current to the load. For example, as shown in a time duration t in FIG. 3A, the output load I_load, which can be Iout in FIG. 1, is at its maximum current during the entire time that phase 2 (PWM2) is delivering current to load 104, and only partially during the times when phases 1 (PWM1) and 3 (PWM3) are delivering current to load 104. The unequal phase distribution for contributing to I_load as shown in FIG. 3A can create phase current imbalance, as the root mean square (RMS) current of phase 2 is significantly higher than that of phase 1 and phase 3, causing losses and thermal stress to concentrate on phase 2.

In an aspect, when the frequency of the output load transient is relatively low (e.g., the load current goes from LOW to HIGH to LOW at a relatively low frequency, the inductor currents I_Phase1, I_Phase2, I_Phase3 can remain balanced during the transitions. As the frequency of the output load transient increases high enough to create a pseudo-resonant condition with the switching frequency of the power converter (e.g., system 100), the per-phase current becomes imbalanced. The spread between the phases can increases and creates the imbalance of component stress and thermal imbalance. Also, this phase imbalance at high output load transient can occur when the ramp signal consistently drops each time a particular phase or PWM goes high, which causes that particular PWM pulse to be consistently shorter (and therefore the current lower) than the other PWM signals.

To be described in more detail below, controller 102 described herein can be configured and programmed to sort and assign ramp signals to different phases to change phase order in order to prevent phase current imbalance due to high frequency dynamic load conditions. By way of example, a ramp signal for phase 1 does not necessarily have to be assigned to phase 1 and can be assigned to another phase. The sorting and reordering of ramp signals can cause the control signals, or the PWM signals, to remain staggered while not necessarily follow a fixed order. Controller 102 can be configured to detect the current of each phase (e.g., phase currents I_Phase1, I_Phase2, I_Phase3) and re-orders the phases based on the sensed current of each phase. If one particular phase is exhibiting higher current relative to the other phases, controller 102 can reorder the phases to allow that particular phase to skip ON cycles in order to rebalance the per-phase current. By continuously sorting and reordering ramp signals to aligning the lowest phase current with a specific ramp signal, the load can be evenly distributed among phases even during high frequency load transients. In one embodiment, when system 100 utilizes decreasing ramps to turn on a PWM phase (e.g., when a ramp signal decreases, its corresponding PWM signal rises), the lowest ramp signal can be assigned to align with the lowest phase current. By way of example, referring to FIG. 3A, a signal event 302 indicates that when the ramp signal VR2 corresponding to PWM2 drops to V_{W-}, PWM2 rises. In another embodiment, when system 100 utilizes increasing ramps to turn on a PWM phase (e.g., when a ramp signal increases, its corresponding PWM signal rises), the highest ramp signal can be assigned to align with the lowest phase current. By way of example, referring to FIG. 3B, a signal event 304 indicates that when the ramp signal VR2 corresponding to PWM2 rises to V_{W+}, PWM2 rises. Therefore, the load can be evenly distributed among phases even during high frequency load transients.

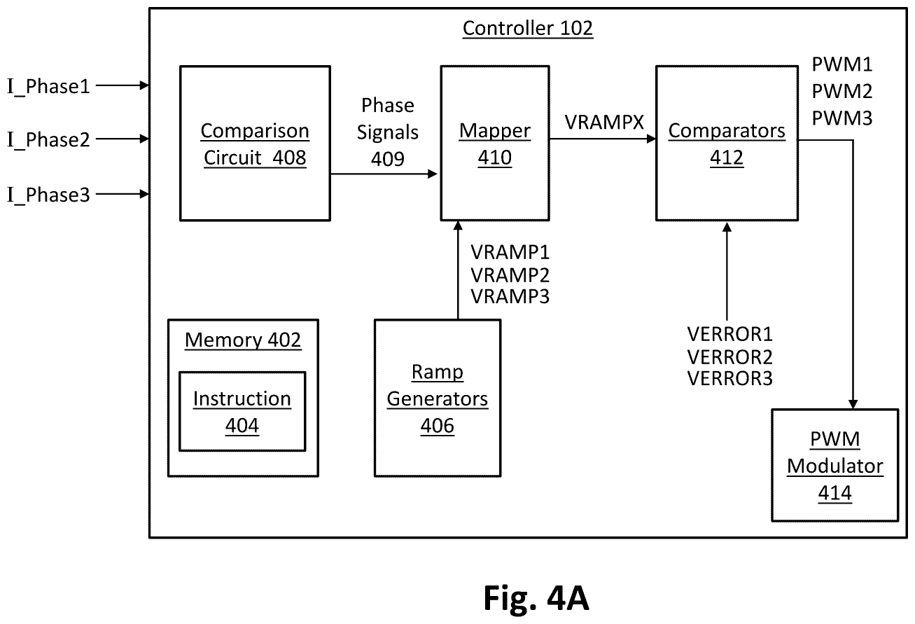

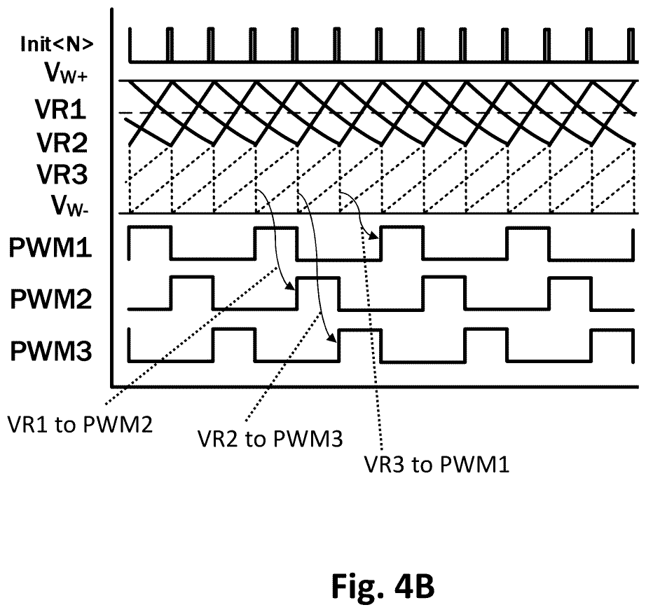

FIG. 4A is a diagram showing an example controller that can implement ramp signal sorting in multiphase power converters in one embodiment. Descriptions of FIG. 4A can reference components shown in FIG. 1 to FIG. 3B. In one embodiment, controller 102 can include a memory 402. Memory 402 can be configured to store a set of instructions 404. In one embodiment, instructions 404 can include different conditions and logic for controller 102 (or components and circuits in controller 102) to determine whether to sort phases in different ways or not. Controller 102 can receive inductor currents of different phases or power stages, such as I_Phase1, I_Phase2, I_Phase3.

Controller 102 can include one or more ramp generators 406 configured to generate a ramp signal for each power stage in system 100. Ramp generators 406 can receive inductor currents of different phases or power stages, such as I_Phase1, I_Phase2, I_Phase3. By way of example, ramp generators 406 can include a plurality of ramp generator circuits, one for each power stage. A first ramp generator among ramp generators 406 can be configured to generate a ramp signal VRAMP1 based on I_Phase1. A second ramp generator among ramp generators 406 can be configured to generate a ramp signal VRAMP2 based on I_Phase2. A third ramp generator among ramp generators 406 can be configured to generate a ramp signal VRAMP3 based on I_Phase3.

Controller 102 can include a comparison circuit 408. Comparison circuit 408 can include one or more comparators configured to compare inductor currents of all phases in system 100. In one embodiment, comparison circuit 408 can further include a sorting circuit configured to sort the inductors currents according to results of the comparisons. Comparison circuit 408 can generate output phase signals 409 indicating an order of the inductor currents, such as ranking the inductor currents from the highest current to the lowest current, or from the lowest current to the highest current.

Controller 102 can further include a mapper 410, where mapper 410 can be a digital logic circuit. Mapper 410 can be programmed to select a specific phase in the sorted phases or ranking indicated by phase signals 409, and select a specific ramp signal among the ramp signals generated by ramp generators 406, according to instructions 404. Mapper 410 can output the selected ramp signal, labeled as VRAMPX to one or more comparators 412 in controller 102. Comparators 412 can include one or more comparators configured to compare ramp signals with error signals for controller 102 to generate PWM signals (see FIG. 2). Under a fixed order of phases, comparators 412 can compare an error signal VERROR1 of power stage PS1 with VRAMP1, error signal VERROR2 of power stage PS2 with VRAMP2, and error signal VERROR3 of power stage PS3 with VRAMP3. However, according to instructions 404 to reorder the phases, comparators 412 can compare the selected VRAMPX with an error voltage of a phase selected by mapper 410. An output of comparators 412 can be used by a PWM modulator 414 of controller 102 to generate the control signals PWM1, PWM2, PWM3 under a new phase order instead of a fixed or default order. In one embodiment, when system 100 utilizes decreasing ramps to turn on a PWM phase (as shown in FIG. 3A), instruction 404 can include commands for mapper 410 to select the lowest ramp signal as VRAMPX. When system 100 utilizes increasing ramps to turn on a PWM phase (as shown in FIG. 3B), instruction 404 can include commands for mapper 410 to select the highest ramp signal as VRAMPX.

In one embodiment, when instruction 404 includes commands for mapper 410 to select the lowest ramp signal as VRAMPX, instruction 404 can indicate that under a first set of conditions: 1) If I_PhaseA>I_PhaseB and VRAMPA<VRAMPB, or 2) I_PhaseA<I_PhaseB and VRAMPA>VRAMPB, controller 102 shall swap Phase A and Phase B ramp signals if both PWM signals of phase A and phase B are LOW and both phases A and B are available and ready to create HIGH pulse. Under the first set of conditions, if I_Phase1<I_Phase2 and VRAMP2<VRAMP1, then mapper 410 will map VRAMP1 to I_Phase2 (power stage PS2) and map VRAMP2 to I_Phase1 (power stage PS1). If I_Phase3<I_Phase1 and VRAMP1<VRAMP3, then mapper 410 will map VRAMP2 to I_Phase3 (power stage PS3) and map VRAMP3 to I_Phase1. In other words, I_Phase3<I_Phase1<I_Phase2 and VRAMP2<VRAMP1<VRAMP3, where I_Phase3 is the lowest phase current and VRAMP2 is the lowest ramp signal. Thus, comparators 412 can compare VRAMP1 with VERROR2 for modulator 414 to generate PWM2, compare VRAMP2 with VERROR3 for modulator 414 to generate PWM3, and compare VRAMP3 with VERROR1 for modulator 414 to generate PWM1. Based on the new mapping or assignment of ramp signals (e.g., reordering ramp signals VR1, VR2, VR3 in FIG. 3A), the new order of the phases are PWM2, PWM3, PWM1. Note that under the first set of conditions, the lowest ramp signal VRAMP2 is mapped to the phase PWM3 with the lowest phase current I_Phase3. An example of this new order is shown in FIG. 4B, where the decrease of ramp signal VR1 will be used for turning on Phase 2 (controls PWM2 rising edge), the decrease of ramp signal VR2 will be used for turning on Phase 3 (controls PWM3 rising edge), and the decrease of ramp signal VR3 will be used for turning on Phase 1 (controls PWM1 rising edge).

In one embodiment, when system 100 includes a relatively high number of phases, slight differences in inductor values among the different phases and coupling of inductors from adjacent phases can cause phases to continuous sort. Excessive sorting can cause some phases to run at frequencies different from other phases even with no load transients are occurring. In this situation, instruction 404 can indicate that under a second set of conditions indicating if: 1) I_PhaseA>I_PhaseB+Tsort and VRAMPA<VRAMPB, or 2) I_PhaseA<I_PhaseB+Tsort and VRAMPA>VRAMPB, where Tsort is a predefined threshold, controller 102 shall swap Phase A and Phase B ramp signals if both PWM signals of phase A and phase B are LOW and both phases A and B are available and ready to create HIGH pulse. The threshold Tsort can be programmable and can add a difference to the phase current differences, which reduces a sensitivity of the system to perform phase sorting, thus prevent excessive sorting of phases. In one embodiment, the second set of conditions can be used in situations where load demand changes at relatively low frequency.

In one embodiment, system 100 can be programmed to follow a fixed phase order and utilize the phase sorting described herein for a specific amount of times, frequencies or under specific predefined conditions. In this situation, instruction 404 can indicate that under a third set of conditions indicating if: 1) I_PhaseA<I_PhaseB+RETURN and VRAMPA<VRAMPB and a phase swap result is close to the fixed phase order, or 2) I_PhaseA>I_PhaseB+RETURN and VRAMPA>VRAMPB and a phase swap result is close to the fixed phase order, where RETURN is a predefined threshold, then controller 102 shall swap Phase A and Phase B ramp signals if both PWM signals of phase A and phase B are LOW and both phases A and B are available and ready to create HIGH pulse. Otherwise, if 3) I_PhaseA>I_PhaseB and VRAMPA<VRAMPB, or 2) I_PhaseA<I_PhaseB+RETURN and VRAMPA>VRAMPB, then controller 102 shall swap Phase A and Phase B ramp signals if both PWM signals of phase A and phase B are LOW and both phases A and B are available and ready to create HIGH pulse. The threshold RETURN can be a predefined threshold that is programmable, and that sets a time or situation to return to the fixed phase order. Under the third set of conditions, phase current balance can be well controlled during high frequency load hits while also returning to a predictable phase order when desired.

In one or more embodiments, the thresholds for the phase sorting described herein, such as Tsort and RETURN, can vary from their predefined value based on the load transient frequencies (e.g., how often the load demand changes) that can be determined based on voltage errors, such as the VERROR signals, and/or compensator outputs (e.g., ramp signals). By way of example, the thresholds can increase as the load transient frequency decreases, and can decrease as the load transient frequency increases. The thresholds can be returned back to their predefined values as the load transients go away. This allows for programmable control of the phase order priority versus high frequency phase balance.

The phase sorting described herein can maintain phase balancing during high frequency load transients. When the phases are balanced, each phase contributes to the load evenly to ensure that no phases will shut down prematurely due to over-current, over-temperature or component failure (or other fault conditions).

In one embodiment, controller 102 can determine to select the lowest phase current as a next phase to go HIGH regardless of phase ordering. This embodiment can avoid a full sorting of all phases, but at relatively high frequency transients, multiple phases can turn on at the same time with each pulse. Therefore, this embodiment can be performed for preventing the first order phase imbalances but may achieve optimal phase balancing when comparing to sorting all phases.

In one embodiment, controller 102 can perform the phase sorting when the phases are deactivated. This embodiment can allow applications with duty cycles that are relatively low (e.g., Vin significantly greater than Vout). Under these applications, when phases get out of order, as soon as a pulse of a phase turns off, controller 102 can detect the phase is out of order and put the phase back in order well before that phase is required to go HIGH again.

In one embodiment, when compensation by ramp signals is negative, the PWM signals shall not be HIGH and controller can freeze the ramp signals until the compensation is no longer negative and a phase goes HIGH. The freezing can prevent the low ramp signals associated with the lowest current from wrapping to the top and therefore requiring all phases to re-sort.

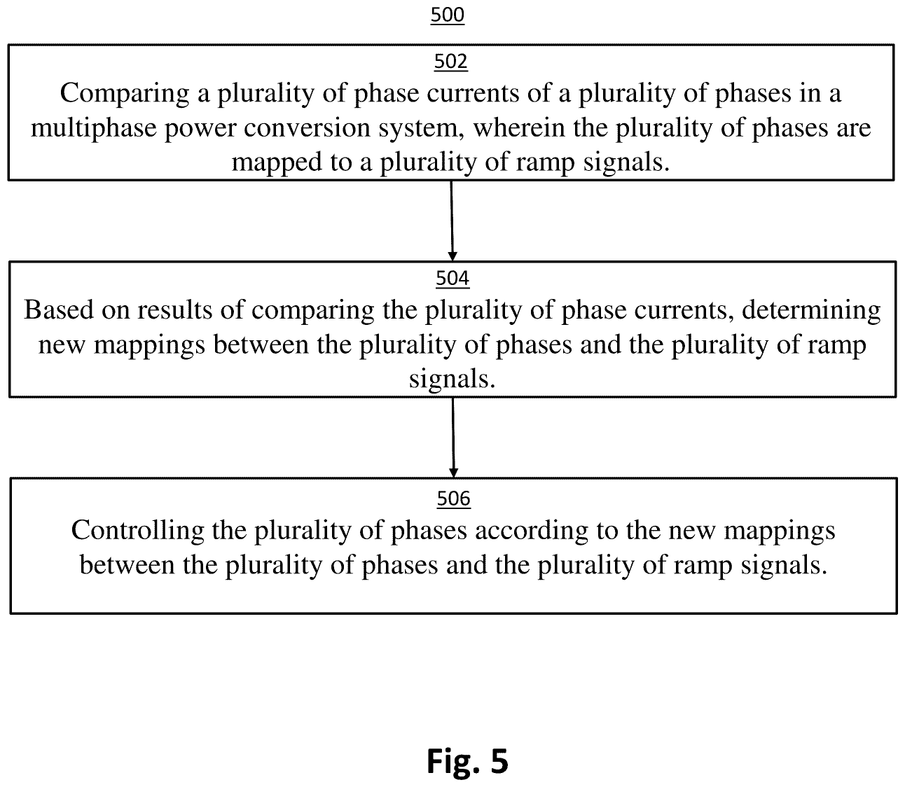

FIG. 5 illustrates a flow diagram of a process to implement ramp signal sorting in multiphase power converters in one embodiment. The process 500 shown in FIG. 5 can include one or more operations, actions, or functions as illustrated by one or more of blocks 502, 504, 506 and/or 508. Although illustrated as discrete blocks, various blocks can be divided into additional blocks, combined into fewer blocks, eliminated, performed in different order, or performed in parallel, depending on the desired implementation.

Process 500 can be performed by multiphase power conversion system such as system 100, described herein. Process 500 can begin at block 502. At block 502, the multiphase power conversion system can compare a plurality of phase currents of a plurality of phases in a multiphase power conversion system. The plurality of phases are mapped to a plurality of ramp signals. Block 502 can continue to block 504. At block 504, the multiphase power conversion system can based on results of comparing the plurality of phase currents, determine new mappings between the plurality of phases and the plurality of ramp signals. Block 504 can continue to block 506. At block 506, the multiphase power conversion system can control the plurality of phases according to the new mappings between the plurality of phases and the plurality of ramp signals.

In another embodiment, the new mappings map a phase having a lowest phase current to a lowest ramp signal.

In another embodiment, the new mappings map a phase having a lowest phase current to a highest ramp signal.

In another embodiment, comparing the plurality of phase currents comprises comparing every pair of phase currents among the plurality of phase currents.

In another embodiment, comparing the plurality of phase currents comprises comparing a first phase current with a second current appended with a threshold.

In another embodiment, comparing the plurality of phase currents of the plurality of phases being controlled according to the new mappings. Based on results of comparing the plurality of phase currents of the plurality of phases being controlled according to the new mappings, determining whether to maintain the new mappings or to determine another set of new mappings between the plurality of phases and the plurality of ramp signals.

In another embodiment, determining the new mappings is performed during a load transient event of the multiphase power conversion system.

### EXAMPLES

Example 1: A method for phase balancing in a multiphase power conversion system, the method comprising: comparing a plurality of phase currents of a plurality of phases in a multiphase power conversion system, wherein the plurality of phases are mapped to a plurality of ramp signals; based on results of comparing the plurality of phase currents, determining new mappings between the plurality of phases and the plurality of ramp signals; and controlling the plurality of phases according to the new mappings between the plurality of phases and the plurality of ramp signals.
Example 2: The method of example 1, wherein the new mappings map a phase having a lowest phase current to a lowest ramp signal.
Example 3: The method of any one of examples 1 to 2, wherein the new mappings map a phase having a lowest phase current to a highest ramp signal.
Example 4: The method of any one of examples 1 to 3, wherein comparing the plurality of phase currents comprises comparing every pair of phase currents among the plurality of phase currents.
Example 5: The method of any one of examples 1 to 4, wherein comparing the plurality of phase currents comprises comparing a first phase current with a second current appended with a threshold.
Example 6: The method of any one of examples 1 to 5, further comprising: comparing the plurality of phase currents of the plurality of phases being controlled according to the new mappings; and based on results of comparing the plurality of phase currents of the plurality of phases being controlled according to the new mappings, determining whether to maintain the new mappings or to determine another set of new mappings between the plurality of phases and the plurality of ramp signals.
Example 7: method of any one of examples 1 to 6, wherein determining the new mappings is performed during a load transient event of the multiphase power conversion system.
Example 8: The system comprising: a multiphase power converter including a plurality of phases; and a controller configured to: compare a plurality of phase currents of the plurality of phases in the multiphase power converter, wherein the plurality of phases are mapped to a plurality of ramp signals; based on results of comparing the plurality of phase currents, determine new mappings between the plurality of phases and the plurality of ramp signals; and control the plurality of phases according to the new mappings between the plurality of phases and the plurality of ramp signals.
Example 9: The system of example 8, wherein the new mappings map a phase having a lowest phase current to a lowest ramp signal.
Example 10: The system of any one of examples 8 to 9, wherein the new mappings map a phase having a lowest phase current to a highest ramp signal.
Example 11: The system of any one of examples 8-10, wherein to compare the plurality of phase currents, the controller is configured to compare every pair of phase currents among the plurality of phase currents.
Example 12: The system of any one of examples 8 to 11, wherein to compare the plurality of phase currents, the controller is configured to compare a first phase current with a second current appended with a threshold.
Example 13: The system of any one of examples 8 to 12, wherein the controller is configured to: compare the plurality of phase currents of the plurality of phases being controlled according to the new mappings; and based on results of the comparison of the plurality of phase currents of the plurality of phases being controlled according to the new mappings, determine whether to maintain the new mappings or to determine another set of new mappings between the plurality of phases and the plurality of ramp signals.
Example 14: The system of any one of examples 8 to 13, wherein the controller is configured to determine the new mappings during a load transient event of the multiphase power conversion system.
Example 15: A semiconductor device comprising: a plurality of comparators configured to compare a plurality of phase currents of a plurality of phases in a multiphase power conversion system, wherein the plurality of phases are mapped to a plurality of ramp signals; a mapping circuit configured to determine, based on results of comparing the plurality of phase currents, new mappings between the plurality of phases and the plurality of ramp signals; and a modulator configured to generate at least one pulse-width modulation (PWM) signal for controlling the plurality of phases according to the new mappings between the plurality of phases and the plurality of ramp signals.
Example 16: The semiconductor device of example 15, wherein the new mappings map a phase having a lowest phase current to a lowest ramp signal.
Example 17: The semiconductor device of any one of examples 15 to 16, wherein the new mappings map a phase having a lowest phase current to a highest ramp signal.
Example 18: The semiconductor device of any one of examples 15 to 17, wherein to compare the plurality of phase currents, the plurality of comparators are configured to compare every pair of phase currents among the plurality of phase currents.
Example 19: The semiconductor device of any one of examples 15 to 18, wherein to compare the plurality of phase currents, the plurality of comparators are configured to compare a first phase current with a second current appended with a threshold.
Example 20: The semiconductor device of any one of examples 15 to 19, wherein: the plurality of comparators are configured to compare the plurality of phase currents of the plurality of phases being controlled according to the new mappings; and the mapping circuit is configured to, based on results of the comparison of the plurality of phase currents of the plurality of phases being controlled according to the new mappings, determine whether to maintain the new mappings or to determine another set of new mappings between the plurality of phases and the plurality of ramp signals.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for phase balancing in a multiphase power conversion system, the method comprising:
comparing a plurality of phase currents of a plurality of phases in a multiphase power conversion system, wherein the plurality of phases are mapped to a plurality of ramp signals;
based on results of comparing the plurality of phase currents, determining new mappings between the plurality of phases and the plurality of ramp signals; and
controlling the plurality of phases according to the new mappings between the plurality of phases and the plurality of ramp signals.

2. The method of claim 1, wherein the new mappings map a phase having a lowest phase current to a lowest ramp signal.

3. The method of claim 1, wherein the new mappings map a phase having a lowest phase current to a highest ramp signal.

4. The method of claim 1, wherein comparing the plurality of phase currents comprises comparing every pair of phase currents among the plurality of phase currents.

5. The method of claim 1, wherein comparing the plurality of phase currents comprises comparing a first phase current with a second current appended with a threshold.

6. The method of claim 1, further comprising:
comparing the plurality of phase currents of the plurality of phases being controlled according to the new mappings; and
based on results of comparing the plurality of phase currents of the plurality of phases being controlled according to the new mappings, determining whether to maintain the new mappings or to determine another set of new mappings between the plurality of phases and the plurality of ramp signals.

7. The method of claim 1, wherein determining the new mappings is performed during a load transient event of the multiphase power conversion system.

8. A system comprising:
a multiphase power converter including a plurality of phases; and
a controller configured to:
compare a plurality of phase currents of the plurality of phases in the multiphase power converter, wherein the plurality of phases are mapped to a plurality of ramp signals;
based on results of comparing the plurality of phase currents, determine new mappings between the plurality of phases and the plurality of ramp signals; and
control the plurality of phases according to the new mappings between the plurality of phases and the plurality of ramp signals.

9. The system of claim 8, wherein the new mappings map a phase having a lowest phase current to a lowest ramp signal.

10. The system of claim 8, wherein the new mappings map a phase having a lowest phase current to a highest ramp signal.

11. The system of claim 8, wherein to compare the plurality of phase currents, the controller is configured to compare every pair of phase currents among the plurality of phase currents.

12. The system of claim 8, wherein to compare the plurality of phase currents, the controller is configured to compare a first phase current with a second current appended with a threshold.

13. The system of claim 8, wherein the controller is configured to:
compare the plurality of phase currents of the plurality of phases being controlled according to the new mappings; and
based on results of the comparison of the plurality of phase currents of the plurality of phases being controlled according to the new mappings, determine whether to maintain the new mappings or to determine another set of new mappings between the plurality of phases and the plurality of ramp signals.

14. The system of claim 8, wherein the controller is configured to determine the new mappings during a load transient event of the multiphase power conversion system.

15. A semiconductor device comprising:
a plurality of comparators configured to compare a plurality of phase currents of a plurality of phases in a multiphase power conversion system, wherein the plurality of phases are mapped to a plurality of ramp signals;
a mapping circuit configured to determine, based on results of comparing the plurality of phase currents, new mappings between the plurality of phases and the plurality of ramp signals; and
a modulator configured to generate at least one pulse-width modulation (PWM) signal for controlling the plurality of phases according to the new mappings between the plurality of phases and the plurality of ramp signals.

16. The semiconductor device of claim 15, wherein the new mappings map a phase having a lowest phase current to a lowest ramp signal.

17. The semiconductor device of claim 15, wherein the new mappings map a phase having a lowest phase current to a highest ramp signal.

18. The semiconductor device of claim 15, wherein to compare the plurality of phase currents, the plurality of comparators are configured to compare every pair of phase currents among the plurality of phase currents.

19. The semiconductor device of claim 15, wherein to compare the plurality of phase currents, the plurality of comparators are configured to compare a first phase current with a second current appended with a threshold.

20. The semiconductor device of claim 15, wherein:
the plurality of comparators are configured to compare the plurality of phase currents of the plurality of phases being controlled according to the new mappings; and
the mapping circuit is configured to, based on results of the comparison of the plurality of phase currents of the plurality of phases being controlled according to the new mappings, determine whether to maintain the new mappings or to determine another set of new mappings between the plurality of phases and the plurality of ramp signals.
